(19) United States
(12) Patent Application Publication
(10) Pub. No.: US 2025/0364558 A1
(43) Pub. Date: Nov. 27, 2025

(54) CONCENTRATION GRADIENT-TYPE NEGATIVE ELECTRODE ACTIVE MATERIAL FOR SECONDARY BATTERY AND METHOD FOR MANUFACTURING SAME

(71) Applicant: SOGANG UNIVERSITY RESEARCH & BUSINESS DEVELOPMENT FOUNDATION, Seoul (KR)

(72) Inventors: Jaegeon Ryu, Seoul (KR); Jin Yong Kwon, Seoul (KR)

(73) Assignee: SOGANG UNIVERSITY RESEARCH & BUSINESS DEVELOPMENT FOUNDATION, Seoul (KR)

(21) Appl. No.: 19/217,734

(22) Filed: May 23, 2025

(30) Foreign Application Priority Data
May 23, 2024 (KR) 10-2024-0067195

(51) Int. Cl. H01M 4/587; C01B 33/02; H01M 4/38

(52) U.S. Cl. CPC H01M 4/587; C01B 33/02; H01M 4/386; C01P 2002/72; C01P 2004/04; C01P 2004/80; C01P 2006/40

(57) ABSTRACT

The present disclosure relates to a negative electrode active material for a secondary battery and a method of manufacturing the same, the negative electrode active material including: silicon forming a concentration gradient that increases from a surface region toward a core region of the active material; and carbon forming a concentration gradient that decreases from the surface region toward the core region of the active material.

### CROSS-REFERENCE TO RELATED APPLICATION

This application claims the benefit under 35 U.S.C. § 119(a) of Korean Patent Application No. 10-2024-0067195, filed on May 23, 2024, the entire disclosure of which is incorporated herein by reference for all purposes.

### BACKGROUND

### 1. Field

The present disclosure relates to a concentration gradient-type negative electrode active material for a secondary battery and a method for manufacturing the same, and more particularly, to a concentration gradient-type negative electrode active material for a secondary battery including silicon formed with a concentration gradient that increases from the surface of the active material toward the center, and a method for manufacturing the same.

### 2. Description of Related Art

Lithium secondary batteries have recently attracted significant attention as energy storage devices due to their high energy density, and are widely utilized in applications such as electric vehicles, drones, and electronic devices. However, the conventionally commercialized negative electrode active material, graphite, exhibits a relatively low specific capacity of 372 mAh/g, which limits its suitability for high-capacity battery systems. As a result, substantial research efforts have been directed toward the development of high-capacity negative electrode active materials, such as conversion-type negative electrode materials including silicon and tin. Among these, silicon offers an exceptionally high theoretical capacity of 3,579 mAh/g. Nevertheless, silicon undergoes a drastic volume expansion of up to approximately 300% during charge and discharge cycles, leading to critical stability issues such as detachment from the electrode structure, formation of unstable interfaces, and mechanical pulverization. These issues significantly reduce the Coulombic efficiency (CE) of the battery and result in rapid capacity degradation. To enable the practical application of silicon as a negative electrode active material, it is essential to form a composite with carbon.

Conventional techniques have attempted to form silicon-carbon composites through point or planar contact between the two materials. However, such physically bonded composites are prone to disintegration during volume changes, as the bonding strength is insufficient to withstand repeated expansion and contraction. In simple mixtures of silicon and carbon, the mismatch in expansion ratios during cycling causes physical separation between the materials, disrupting electron transport pathways within the electrode. Likewise, methods involving carbon coatings on silicon particles or dispersing carbon within silicon structures are also vulnerable to delamination or detachment due to this expansion mismatch. These structural failures lead to sharp declines in capacity and increase the likelihood of undesirable side reactions, severely degrading overall battery performance. In summary, conventional technologies relying solely on simple physical bonding to form silicon-carbon composite layers suffer from weak interfacial integrity, making them prone to mechanical failure.

### SUMMARY

The present disclosure has been devised to solve the aforementioned problems, and aims to provide a concentration gradient-type negative electrode active material for a secondary battery, and a method for manufacturing the same, capable of suppressing battery performance degradation caused by the volume expansion of silicon.

In one general aspect, a negative electrode active material for a secondary battery includes: silicon forming a concentration gradient that increases from a surface region toward a core region of the active material; and carbon forming a concentration gradient that decreases from the surface region toward the core region of the active material.

A silicon content in a core region of a particle of the active material may be in a range of 95% to 100%. A carbon content in a surface region of the particle may be in a range of 95% to 100%.

A concentration gradient of the silicon may have a slope in a range of −3 to 0.

In another general aspect, a method for manufacturing a negative electrode active material for a secondary battery includes: mixing a coating precursor material with a carrier solvent to prevent a coating precursor solution; introducing silicon into a furnace and heating an interior of the furnace; and introducing the coating precursor solution into the heated interior of the furnace.

The coating precursor material may include one or more substances selected from a group consisting of tetramethylsilane, tris(dimethylamino)silane, trimethyl(phenyl)silane, trimethyl(propargyl)silane, trimethyl(trifluoromethyl)silane, tert-butyldimethyl(2-propynyloxy)silane, trimethyl(methylthio)silane, trimethyl(phenylthio)silane, vinyltrimethylsilane, ethynyltrimethylsilane, triethyl(trifluoromethyl)silane, trimethylsilane, hexamethyldisilane, bromotrimethylsilane, 1-phenyl-2-trimethylsilylacetylene, and phenylsilane.

A temperature for the heating may be in a range of 300° C. to 1000° C.

The coating precursor solution may be introduced into the furnace at a flow rate in a range of 50 to 300 mL/min.

A time during which the coating precursor solution may be introduced into the heated furnace is in a range of 5 to 120 minutes.

As the coating precursor solution is introduced into the heated furnace, the coating precursor material may be thermally decomposed and continuously deposited on a surface of the silicon.

The coating precursor material may be mixed with the carrier solvent in an amount of 50 to 500 parts by weight based on 100 parts by weight of the silicon.

In another general aspect, a negative electrode for a secondary battery includes a negative electrode active material manufactured by the above-described method.

The concentration gradient-type negative electrode active material for a secondary battery according to the present disclosure exhibits excellent mechanical properties due to the introduction of an intermediate layer having continuous atomic-level bonding, and allows stress generated within the material to be effectively alleviated.

In addition, the method for manufacturing the concentration gradient-type negative electrode active material according to the present disclosure enables the production of an active material having a continuous concentration gradient through a simple process involving the replacement of a coating precursor.

### BRIEF DESCRIPTION OF THE DRAWINGS

FIG. 1 is a schematic view illustrating a concentration gradient-type negative electrode active material for a secondary battery according to the present disclosure.

FIG. 2 is a flowchart illustrating a method for manufacturing a concentration gradient-type negative electrode active material for a secondary battery according to the present disclosure.

FIG. 3 is a schematic diagram illustrating the manufacturing process of the concentration gradient-type negative electrode active material for a secondary battery according to the present disclosure.

FIG. 4 is an XRD spectrum of a negative electrode active material for a secondary battery manufactured according to an example of the present disclosure.

FIG. 5 is a TEM image of a negative electrode active material for a secondary battery manufactured according to an example of the present disclosure.

FIG. 6 is an electron microscope elemental analysis result of a negative electrode active material for a secondary battery manufactured according to an example of the present disclosure.

FIG. 7 is a graph showing battery capacity over cycles of a half-cell manufactured according to an example of the present invention.

FIG. 8 is a set of graphs showing the Si/C elemental ratio of a negative electrode active material for a secondary battery manufactured according to an example of the present disclosure, and the battery capacity over cycles of a half-cell fabricated using the active material.

### DETAILED DESCRIPTION

The present disclosure is subject to various modifications and may take on multiple embodiments. Specific exemplary embodiments are illustrated in the drawings and described in detail in the following description. However, such examples are not intended to limit the disclosure to particular forms, and it should be understood that all modifications, equivalents, and substitutes that fall within the spirit and scope of the disclosure are encompassed thereby.

Throughout this specification, when a part or element is described as “including” a feature or component, it is to be understood that, unless otherwise explicitly stated, the inclusion does not exclude the presence of additional components or features.

The terms “about,” “substantially,” and similar expressions as used herein are intended to account for manufacturing tolerances or material variations that are inherent in the stated values. These terms are also intended to prevent unscrupulous parties from unfairly exploiting the disclosure by interpreting precise or absolute numerical expressions in a way not intended by the inventor. Furthermore, the expressions such as “step of ˜” or “the step of ˜” used throughout the specification do not imply any step for achieving a particular purpose unless explicitly stated.

A person of ordinary skill in the art to which the present disclosure pertains will appreciate that various applications and modifications can be made in light of the teachings of the present disclosure. Therefore, the scope of protection of the present disclosure is not limited to the following embodiments. Rather, the scope of protection is defined by the appended claims, and extends to any obvious variations, substitutions, or modifications that fall within the scope of the claims as understood by those of ordinary skill in the art using conventional knowledge.

Hereinafter, the present disclosure will be described in further detail with reference to the accompanying drawings, where necessary.

### Concentration Gradient-Type Negative Electrode Active Material for Secondary Battery

As a means for achieving the aforementioned objectives, the present disclosure provides a negative electrode active material for a secondary battery, including: silicon forming a concentration gradient that increases from the surface of the active material toward the center; and carbon forming a concentration gradient that decreases from the surface of the active material toward the center.

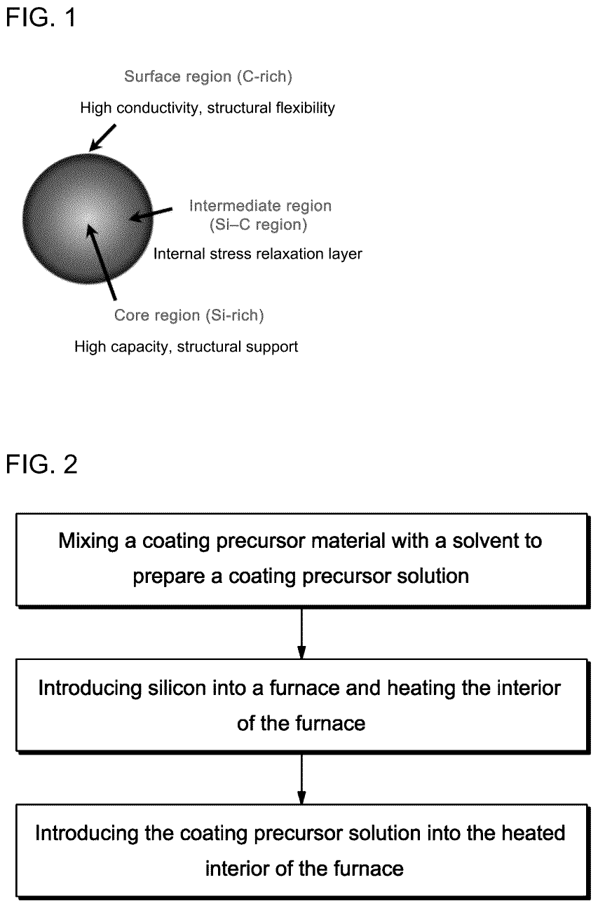

FIG. 1 is a schematic view illustrating an example of the concentration gradient-type negative electrode active material according to the present disclosure.

Referring to FIG. 1, the present disclosure includes: a surface region rich in carbon (C); a core region rich in silicon (Si); and an intermediate region having continuous atomic-level bonding between the C and Si elements. In the intermediate region, the carbon element is formed with a concentration gradient decreasing toward the core region, and the silicon element is formed with a concentration gradient increasing toward the core region.

That is, the concentration gradient-type negative electrode active material for a secondary battery according to the present disclosure may achieve high electrical conductivity and structural flexibility through the formation of a carbon-rich surface region, and may attain a high-capacity negative electrode active material while structurally supporting the material through the formation of a silicon-rich core region. Furthermore, by introducing an intermediate region having continuous atomic-level bonding, the concentration gradient-type negative electrode active material of the present disclosure may enhance the bonding strength between the active material and a coating layer. A negative electrode active material including such an intermediate region with continuous atomic-level bonding may exhibit excellent mechanical properties and efficiently alleviate internal stress, thereby preventing structural collapse and degradation of battery performance caused by volume expansion.

Here, the silicon content in the core region of the active material particle may be from 95% to 100%, and the carbon content in the surface region of the active material particle may be from 95% to 100%.

Here, the silicon concentration gradient may be in the range of −3 to 0. The silicon concentration gradient may be derived using the following equation.

$$Concentration Gradient ( y ) = {f}^{′} ( x ) \qquad Equation 1$$

In the above equation, x represents the distance from the center (0, 0) of the negative electrode active material particle for a secondary battery according to the present disclosure. The function f(x) represents the silicon concentration as a function of distance from the center of the active material particle, and may be expressed as a first-order or second-order polynomial function. The function f′(x) is the derivative of the silicon concentration function f(x), which is expressed as a first-order or second-order polynomial function based on the distance from the center of the negative electrode active material particle for a secondary battery, and the silicon concentration gradient may be calculated by substituting the distance x within the negative electrode active material particle into f′(x). For example, in Example 1 described below, the silicon concentration function f(x) according to the distance within the negative electrode active material particle for a secondary battery is given by f(x)=0.0358x²−3.7372x+99.029, and its derivative is f′(x)=0.0716x−3.7372. The silicon concentration gradient at a distance of 30 nm from the center (0 nm) within the negative electrode active material particle in Example 1 is −1.5892.

In the present disclosure, the fact that the silicon concentration gradient is in the range of −3 to 0 may indicate that the silicon particles within the negative electrode active material particle for a secondary battery form a concentration gradient that decreases from the core region toward the surface region of the active material, or in other words, a concentration gradient that increases from the surface region toward the core region of the active material. In addition, the above-described range of the silicon concentration gradient may indicate that a continuous concentration gradient is formed within the negative electrode active material particle of the present disclosure, without an abrupt increase or decrease in the silicon concentration.

Furthermore, the carbon concentration gradient may be in the range of 0 to 3, and the carbon concentration gradient may likewise be derived using Equation 1 described above.

### Method for Manufacturing a Concentration Gradient-Type Negative Electrode Active Material for Secondary Battery

The present disclosure also provides, as a means for achieving the aforementioned objectives, a method for manufacturing a negative electrode active material for a secondary battery.

FIG. 2 is a flowchart illustrating the manufacturing process of the concentration gradient-type negative electrode active material for a secondary battery according to the present disclosure. Referring to FIG. 2, the process includes: mixing a coating precursor material and a carrier solvent to prepare a coating precursor solution; introducing silicon into a furnace and heating the interior of the furnace; and introducing the coating precursor solution into the heated furnace.

Hereinafter, the manufacturing method of the present disclosure will be described in further detail by subdividing it into individual process steps.

First, the method for manufacturing a concentration gradient-type negative electrode active material for a secondary battery according to the present disclosure includes mixing a coating precursor material with a carrier solvent to prepare a coating precursor solution.

The coating precursor material may include one or more substances selected from the group consisting of tetramethylsilane, tris(dimethylamino)silane, trimethyl(phenyl)silane, trimethyl(propargyl)silane, trimethyl(trifluoromethyl)silane, tert-butyldimethyl(2-propynyloxy)silane, trimethyl(methylthio)silane, trimethyl(phenylthio)silane, vinyltrimethylsilane, ethynyltrimethylsilane, triethyl(trifluoromethyl)silane, trimethylsilane, hexamethyldisilane, bromotrimethylsilane, 1-phenyl-2-trimethylsilylacetylene, and phenylsilane, but is not limited thereto.

The carrier solvent may be, but is not limited to, toluene, benzene, hexane, or pentane.

The coating precursor material may be mixed with the carrier solvent in an amount of 50 to 500 parts by weight based on 100 parts by weight of the silicon. The parts by weight of the coating precursor material may be appropriately selected depending on the type of the coating precursor material and the intended thickness of the intermediate region. However, if the coating precursor material is mixed in an amount less than 50 parts by weight relative to 100 parts by weight of the silicon, it may be difficult to effectively improve the mechanical properties of the negative electrode active material. In contrast, if the coating precursor material is mixed in an amount exceeding 500 parts by weight relative to 100 parts by weight of the silicon, it may lead to a decrease in the negative electrode capacity.

Next, the method for manufacturing a concentration gradient-type negative electrode active material for a secondary battery according to the present disclosure includes introducing silicon into a furnace and heating the interior of the furnace.

The silicon may be crystalline silicon, amorphous silicon, or a mixture thereof. According to an example of the present disclosure, it is preferable that the silicon is crystalline silicon.

The heating temperature may range from 300° C. to 1000° C. The heating temperature may be set based on the thermal decomposition temperature of the coating precursor material, and in other words, the heating temperature may vary depending on the type of the coating precursor material. Table 1 below shows the thermal decomposition temperatures of various coating precursor materials.

TABLE 1

| | | | Thermal |
|---|---|---|---|
| | | | Decomposition |
| Chemical Structure | Compound Name | Boiling Point (° C.) | Temperature (° C.) |
| 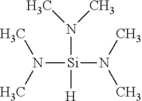 | Tris(dimethylamino)silane | 142 | 900-1000 |
| 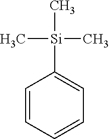 | Trimethyl(phenyl)silane | 160 | 400-500 |
| 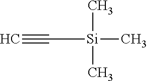 | Ethynyltrimethylsilane | 53 | 600-800 |
| 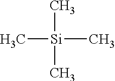 | Tetramethylsilane | 26 | 700-800 |
| 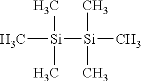 | Hexamethyldisilane | 112 | 640-800 |

Referring to Table 1, when trimethyl(phenyl)silane is used as the coating precursor material, it is preferable to set the heating temperature in the range of 350° C. to 550° C., and more preferably in the range of 450° C. to 500° C. In addition, when tris(dimethylamino)silane is used as the coating precursor material, it is preferable to set the heating temperature in the range of 850° C. to 1100° C., and more preferably in the range of 950° C. to 1000° C. That is, the manufacturing method of the present disclosure may appropriately select and apply the heating temperature depending on the type of coating precursor material.

Next, the method for manufacturing a concentration gradient-type negative electrode active material for a secondary battery according to the present disclosure includes introducing the coating precursor solution into the heated furnace. The manufacturing method of the present disclosure may use a single type of coating precursor solution or a mixed solution of two or more types. In the case where multiple coating precursor solutions are used, each coating precursor solution may be introduced into the furnace in a multi-step manner. For example, a first coating precursor solution may be introduced into the heated furnace for a certain period of time, followed by the introduction of a second coating precursor solution—prepared using a coating precursor material and carrier solvent different from those used in the first coating precursor solution—into the same furnace for another period of time. Through this process, it is possible to form an intermediate region having a complex concentration gradient.

As the coating precursor solution is introduced into the heated furnace, the coating precursor material undergoes thermal decomposition and may be continuously deposited on the surface of the silicon. In other words, the manufacturing method of the negative electrode active material for a secondary battery according to the present disclosure can achieve the effect of coating an intermediate region (Si and C) having a continuous concentration gradient on the surface of the silicon through a simplified process, without requiring multiple separate deposition steps. In addition, since the intermediate region thus formed establishes continuous atomic-level bonding between Si and C, it is also expected to effectively alleviate internal stress caused by the volume expansion of the silicon in the core region. The coating precursor solution is preferably introduced into the furnace at a flow rate of 50 to 300 mL/min, and more preferably at a flow rate of 100 to 200 mL/min. If the flow rate deviates from the above range, there may be a problem in which the coating precursor material is not uniformly coated onto the surface of the silicon.

The coating precursor solution is preferably introduced into the furnace for a duration of 5 to 120 minutes, and more preferably for 5 to 60 minutes. In the manufacturing method of the present disclosure, by maintaining a constant concentration of the coating precursor solution and controlling the introduction time, it is possible to achieve the effect of forming an intermediate region having a target thickness.

In addition, the method for manufacturing a negative electrode active material for a secondary battery according to the present disclosure may further include introducing the carrier solvent into the heated furnace after the coating precursor solution has been introduced into the heated furnace. In the manufacturing method of the present disclosure, by introducing only the carrier solvent into the furnace during the final stage, it is possible to form an outermost layer on the surface of the negative electrode active material having a carbon content of 100%.

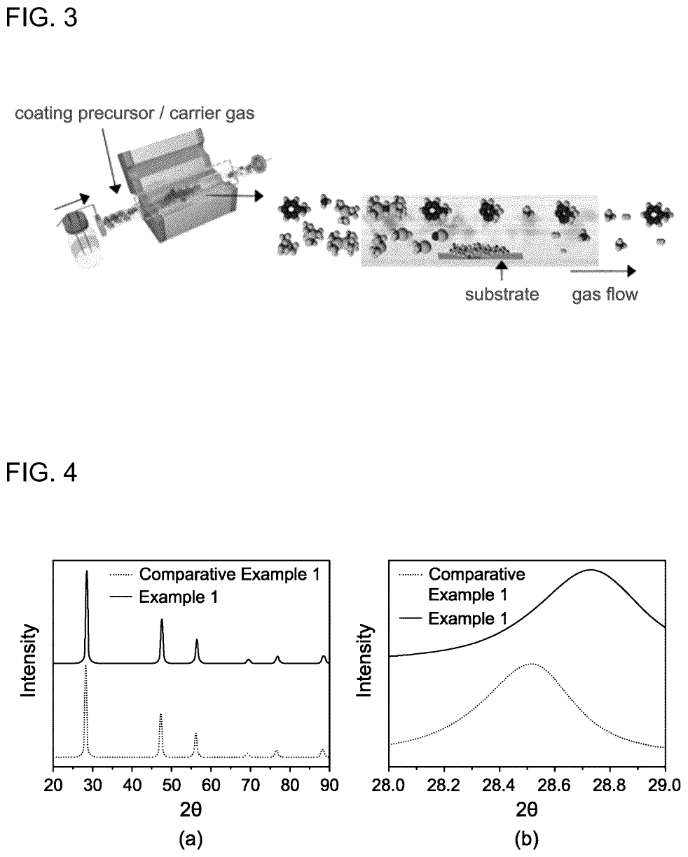

FIG. 3 is a schematic diagram illustrating the manufacturing process of the concentration gradient-type negative electrode active material for a secondary battery according to the present disclosure. A more detailed explanation of the manufacturing method of the present disclosure with reference to FIG. 3 is as follows.

Specifically, in the manufacturing method of the present disclosure, after introducing silicon into a furnace, an inert gas may be introduced to remove oxygen from the interior of the furnace and create an inert atmosphere. The inert gas may be, for example, argon gas, although it is not limited thereto, and the flow rate may range from 100 to 1000 mL/min. Afterward, the furnace may be heated, and the coating precursor solution (i.e., coating precursor material+carrier solvent) may be introduced into the furnace together with a carrier gas through bubbling. The carrier gas may be the same as the inert gas and may also be argon gas, though not limited thereto. At this time, the flow rate and introduction time of the coating precursor solution into the furnace are as described above. As the coating precursor solution is introduced into the heated furnace, the coating precursor material undergoes thermal decomposition and is coated onto the surface of the introduced silicon. At this point, the Si and C elements contained in the coating precursor solution may be coated on the silicon surface so as to exhibit continuous elemental bonding and a concentration gradient, without requiring a separate processing step.

After the coating precursor is deposited on the surface of the silicon, an inert gas may additionally be introduced to establish an inert atmosphere, and the carrier solvent (e.g., toluene) alone may then be introduced into the furnace again by bubbling using the carrier gas. Through this process, a carbon layer having an elemental composition ratio of 95% to 100% may be formed on the outermost surface of the silicon coated with the coating precursor. Finally, the interior of the furnace may be stabilized under the inert atmosphere, followed by cooling, thereby obtaining the final concentration gradient-type negative electrode active material for a secondary battery.

### Negative Electrode for Secondary Battery and Lithium Secondary Battery Including the Same

The present disclosure also provides, as a means for achieving the aforementioned objectives, a negative electrode for a secondary battery, which includes the negative electrode active material for a secondary battery manufactured by the method described above.

The negative electrode for a secondary battery according to the present disclosure may further include a conventionally known current collector, binder, and conductive material, in addition to the above-described negative electrode active material for a secondary battery.

The current collector may be, for example, a metal thin film, and more specifically, may include an aluminum thin film, copper thin film, nickel thin film, stainless steel thin film, titanium thin film, nickel foam, copper foam, a polymer substrate coated with a conductive metal, or a combination thereof, although not limited thereto.

The binder serves to firmly attach the negative electrode active material particles to one another and to ensure good adhesion of the active material to the current collector. When the binder is added to the negative electrode active material composition, the content of the binder may be from 1 wt % to 20 wt % based on the total weight of the negative electrode active material.

The binder may be a water-insoluble binder, a water-soluble binder, or a combination thereof. The water-insoluble binder may include, for example, polyvinyl chloride, carboxylated polyvinyl chloride, polyvinyl fluoride, polymers containing ethylene oxide, polyvinylpyrrolidone, polyurethane, polytetrafluoroethylene, polyvinylidene fluoride, polyethylene, polypropylene, polyamide-imide, polyimide, or a combination thereof. The water-soluble binder may include, for example, styrene-butadiene rubber (SBR), acrylated styrene-butadiene rubber, polyvinyl alcohol, sodium polyacrylate, a copolymer of propylene and olefins having 2 to 8 carbon atoms, a copolymer of (meth)acrylic acid and (meth)acrylic acid alkyl esters, or a combination thereof.

When a water-soluble binder is used as the binders for the negative electrode, a cellulose-based compound capable of imparting viscosity may be further included. Such cellulose-based compounds may include one or more selected from carboxymethyl cellulose, hydroxypropyl methyl cellulose, methyl cellulose, or alkali metal salts thereof. The alkali metal may be Na, K, or Li. The content of the thickener may be from 0.1 parts by weight to 3 parts by weight based on 100 parts by weight of the binder for the negative electrode.

The conductive material is not particularly limited as long as it is electrically conductive and does not cause chemical changes in the battery. Examples include carbon powders such as carbon black, acetylene black, Ketjen black, channel black, furnace black, lamp black, or thermal black; graphite powders such as highly crystalline natural graphite, artificial graphite, or graphite; conductive fibers such as carbon fibers or metal fibers; metal powders such as fluorinated carbon, aluminum, or nickel; conductive whiskers such as zinc oxide or potassium titanate; conductive metal oxides such as titanium oxide; and conductive materials such as polyphenylene derivatives. Specific examples of commercially available conductive materials include acetylene black (manufactured by Chevron Chemical Company, Denka Singapore Private Limited, or Gulf Oil Company), Ketjenblack, the EC series (manufactured by Armak Company), Vulcan XC-72 (manufactured by Cabot Company), and Super-P (manufactured by Timcal).

The negative electrode active material composition may further include a solvent. A representative example of the solvent is N-methylpyrrolidone (NMP). When a water-soluble binder is used, water may be used as the solvent; however, the solvent is not limited thereto.

The present disclosure also provides, as a means for achieving the aforementioned objectives, a lithium secondary battery including a negative electrode for a secondary battery that comprises the above-described negative electrode active material.

The lithium secondary battery according to the present disclosure may be classified as a lithium-ion battery, lithium-ion polymer battery, or lithium polymer battery depending on the type of separator and electrolyte used. It may also be classified by shape into cylindrical, prismatic, coin-type, or pouch-type batteries, and by size into bulk type or thin-film type. The structures and manufacturing methods of these batteries are well known in the art and will not be described in further detail herein.

A lithium secondary battery according to an example of the present disclosure may include: a negative electrode comprising the negative electrode active material manufactured in accordance with an example of the present disclosure; a positive electrode comprising a positive electrode active material; and a non-aqueous electrolyte. The positive electrode comprising the positive electrode active material and the non-aqueous electrolyte may be formed using conventionally known materials.

Hereinafter, the subject matter of the present disclosure will be described in greater detail with reference to the accompanying drawings and examples. However, the drawings and examples presented in this specification may be modified in various ways by those of ordinary skill in the art and may take on different forms. Therefore, the descriptions provided in the present disclosure are not intended to limit the invention to specific disclosed embodiments, but should be construed to include all equivalents and substitutions that fall within the spirit and scope of the present disclosure. In addition, the accompanying drawings are provided to facilitate a more accurate understanding of the present disclosure by those of ordinary skill in the art and may be exaggerated or reduced in scale compared to actual proportions.

### EXAMPLES AND EVALUATION

### Example

### Example 1

After grinding 0.1 g of silicon nanoparticles using an agate mortar, the particles were placed in a square alumina boat and then loaded into a quartz furnace. To remove oxygen from the interior of the furnace, argon gas was introduced for 30 minutes to establish an inert atmosphere, and the argon gas flow rate was maintained at 500 mL/min. After raising the furnace temperature to 750° C., 15 mL of tetramethylsilane and 15 mL of toluene were mixed in a flask. Argon gas was introduced at a flow rate of 150 mL/min to perform bubbling, and the coating was carried out for 15 minutes. After the coating process, argon gas was introduced at a flow rate of 500 mL/min to maintain the inert atmosphere and stabilize the coated particles for 1 hour. Then, 30 mL of toluene was placed in a flask, and argon gas was again introduced at a flow rate of 150 mL/min to perform bubbling and conduct a second coating for 15 minutes. After the second coating, argon gas was introduced at a flow rate of 500 mL/min to maintain the inert atmosphere and stabilize the coated particles for 1 hour. After cooling the furnace, the sample was collected, and the particles were ground using an agate mortar to obtain a concentration gradient-type negative electrode active material for a secondary battery (hereinafter referred to as “Example 1”).

### Comparative Example 1

After grinding 0.1 g of silicon nanoparticles using an agate mortar, the particles were placed in a square alumina boat and then loaded into a quartz furnace. To remove oxygen from the interior of the furnace, argon gas was introduced for 30 minutes to create an inert atmosphere, after which the argon gas flow rate was maintained at 500 mL/min. Then, 30 mL of toluene was placed in a flask, and argon gas was introduced at a flow rate of 150 mL/min to perform bubbling, and the coating was carried out for 45 minutes. After the coating process, argon gas was introduced at a flow rate of 500 mL/min to maintain the inert atmosphere and stabilize the coated particles for 1 hour. After cooling the furnace, the sample was collected, and the particles were ground using an agate mortar to obtain a negative electrode active material for a secondary battery (hereinafter referred to as “Comparative Example 1”).

### Comparative Example 2

After grinding 0.1 g of silicon nanoparticles using an agate mortar, the particles were placed in a square alumina boat and then loaded into a quartz furnace. To remove oxygen from the interior of the furnace, argon gas was introduced for 30 minutes to create an inert atmosphere, after which the argon gas flow rate was maintained at 500 mL/min. Then, 30 mL of toluene was placed in a flask, and argon gas was introduced at a flow rate of 150 mL/min to perform bubbling, and the coating was carried out for 45 minutes. After that, 15 mL of tetramethylsilane and 15 mL of toluene were mixed in a flask, and argon gas was introduced at a flow rate of 150 mL/min to perform bubbling, and a second coating was conducted for 15 minutes. After the coating process, argon gas was introduced at a flow rate of 500 mL/min to maintain the inert atmosphere and stabilize the coated particles for 1 hour. After cooling the furnace, the sample was collected, and the particles were ground using an agate mortar to obtain a negative electrode active material for a secondary battery (hereinafter referred to as “Comparative Example 2”).

### Evaluation

FIG. 4 shows the XRD spectrum of the negative electrode active material for a secondary battery prepared according to an example of the present disclosure. More specifically, (a) of FIG. 4 illustrates the XRD spectra of Example 1 and Comparative Example 1 in the range of 20° to 90°, and (b) of FIG. 4 illustrates the XRD spectra of Example 1 and Comparative Example 1 in the range of 28.0° to 29.0°.

Referring to FIG. 4, it can be confirmed that both the example and comparative example exhibit diffraction peaks in the crystal orientations of 111 (28° to 29°), 220 (approximately 47.5°), 311 (approximately 57°), 400 (approximately 69°), 331 (approximately 77°), and 422 (approximately 88°), which are mostly consistent with the peaks observed in crystalline silicon. However, in the case of Example 1, the peak corresponding to the 111 crystal orientation is observed to be shifted to the right. This shift may be attributed to the formation of a continuous concentration gradient of silicon and carbon from the core region, which may cause changes in elemental interactions within the intermediate region, thereby resulting in a microstructure that differs from that of crystalline silicon.

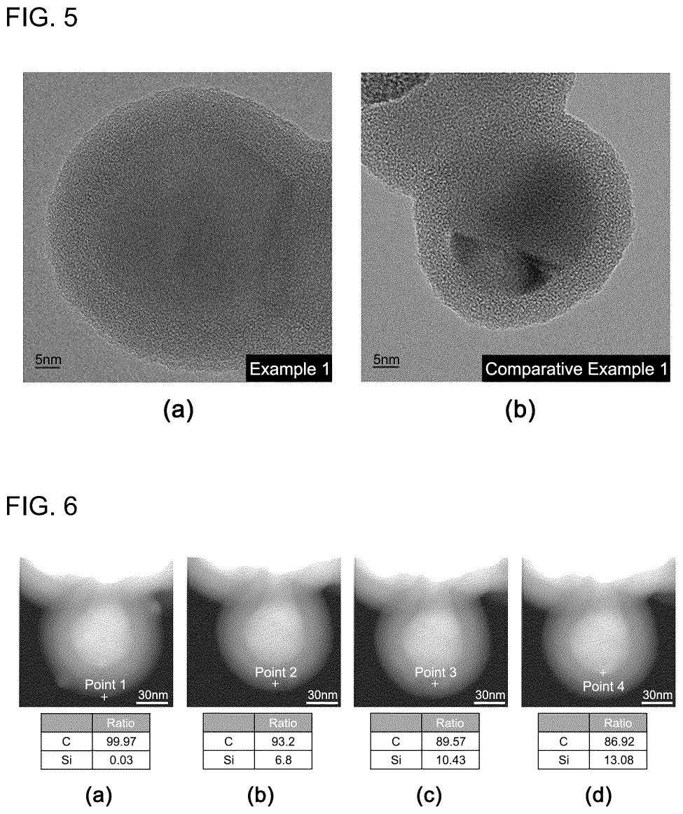

FIG. 5 shows a TEM image of the negative electrode active material for a secondary battery prepared according to an example of the present disclosure. More specifically, (a) of FIG. 5 shows the TEM image of Example 1, and (b) of FIG. 5 shows the TEM image of Comparative Example 1.

Referring to FIG. 5, in the case of Example 1, it can be confirmed that the boundary between the core region and the surface region is indistinct. This is attributed to the presence of silicon forming a concentration gradient that increases from the surface region of the active material toward the core region, and carbon forming a concentration gradient that decreases from the surface region toward the core region. In contrast, in the case of Comparative Example 1, where no coating precursor such as tetramethylsilane was used on the surface of the silicon particles, a distinct interface between the core region and surface region can be observed.

FIG. 6 shows the electron microscopy-based elemental analysis results of the negative electrode active material for a secondary battery prepared according to an example of the present disclosure. More specifically, (a) to (d) of FIG. 6 illustrate the elemental distribution from the surface region to the core region of Example 1.

Referring to FIG. 6, it can be confirmed that the negative electrode active material for a secondary battery according to the present disclosure exhibits an elemental ratio of C:Si=99.97:0.03 in the surface region, and that the silicon content gradually increases toward the core region.

In addition, in the present disclosure, the coating efficiency may vary depending on the type of coating precursor used. Table 2 below shows the coating ratio for each type of coating precursor. The specific coating precursors are tetramethylsilane, 1-phenyl-2-trimethylsilylacetylene, ethynyltrimethylsilane, and trimethyl(trifluoromethyl)silane.

TABLE 2

| | Weight Before | Weight After | |
|---|---|---|---|
| Type of Coating Precursor | Coating (g) | Coating (g) | Coating Ratio (%) |
| 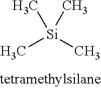 | 0.2 | 0.3412 | 70.6 |
| 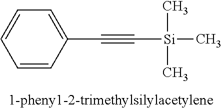 | 0.2 | 0.3348 | 67.4 |
| 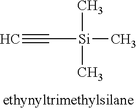 | 0.2 | 0.3157 | 57.85 |
| 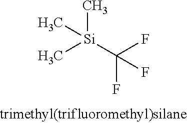 | 0.2 | 0.3498 | 74.9 |

Referring to Table 2, it can be confirmed that the highest coating efficiency is observed when trimethyl(trifluoromethyl)silane is used, and that there are slight differences in coating efficiency depending on the type of coating precursor used.

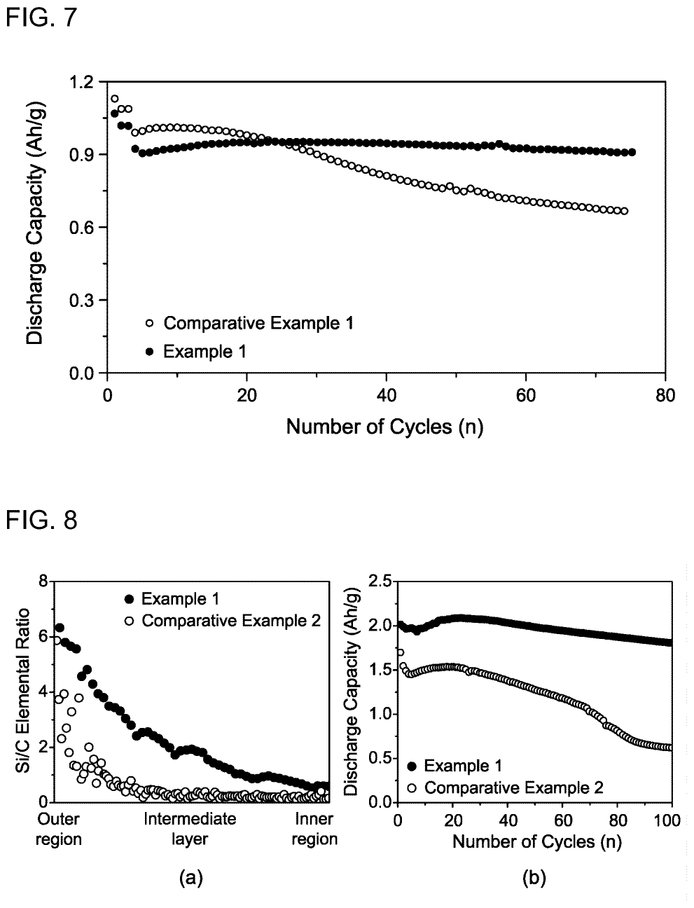

FIG. 7 is a graph illustrating battery capacity over cycles of a half-cell manufactured according to an example of the present disclosure. The secondary battery evaluated in FIG. 7 was fabricated as follows.

First, a slurry was prepared by mixing the negative electrode active material obtained from Example 1 and Comparative Example 1 with acetylene black powder as a conductive material and polyacrylic acid as a binder, and an electrode was manufactured by casting the slurry onto a current collector. The weight ratio of the manufactured electrode was active material:conductive material:binder=60:20:20. Drying was performed under vacuum at 120° C. for 6 hours. The resulting electrode was used as a working electrode, and a lithium metal disk was used as both a counter electrode and a reference electrode to fabricate a half-cell in the form of a coin cell. A polypropylene separator was employed, and a liquid electrolyte of 1.3 M LiPF6 in EC/DEC (3/7, v/v) with 10% FEC was used.

Referring to FIG. 7, in the case of the half-cell fabricated using Example 1, the initial discharge capacity was approximately 1.05 Ah/g. Although the discharge capacity slightly decreased as cycling proceeded, it was confirmed that a discharge capacity of approximately 0.9 Ah/g was maintained up to 80 cycles. In contrast, in the case of the half-cell fabricated using Comparative Example 1, the initial discharge capacity was about 1.13 Ah/g, but the discharge capacity progressively decreased over cycling, resulting in a discharge capacity of about 0.6 Ah/g after 80 cycles. These results are attributed to the fact that the negative electrode active material for a secondary battery according to the present disclosure includes an intermediate region having continuous atomic-level bonding, which effectively alleviates stress generated inside the active material.

FIG. 8 is a graph illustrating the Si/C elemental ratio of a negative electrode active material for a secondary battery manufactured according to an example of the present disclosure, and the battery capacity over cycles of a half-cell fabricated using the active material. More specifically, (a) of FIG. 8 is a graph showing the Si/C elemental ratio of the negative electrode active materials for a secondary battery prepared according to Example 1 and Comparative Example 2, and (b) of FIG. 8 is a graph showing the battery capacity over cycles of half-cells fabricated using the negative electrode active materials for a secondary battery prepared according to Example 1 and Comparative Example 2.

Referring to (a) of FIG. 8, it can be confirmed that in both Example 1 and Comparative Example 2, the concentration of Si is higher in the outer region and decreases toward the inner region. However, in the case of Comparative Example 2, it can be observed that the concentration gradient changes more abruptly from the outer layer to the inner region compared to Example 1. In light of this, referring to (b) of FIG. 8, it can be confirmed that Comparative Example 2 exhibits not only a lower initial discharge capacity than Example 1 but also a gradual decrease in discharge capacity as the cycling proceeds.

The concentration gradient-type negative electrode active material for a secondary battery according to the present disclosure includes an intermediate region having continuous atomic-level bonding, thereby exhibiting excellent mechanical properties while efficiently alleviating stress generated within the material.

In addition, the method for manufacturing the concentration gradient-type negative electrode active material for a secondary battery according to the present disclosure allows for the production of a negative electrode active material having a continuous concentration gradient through a simple process of replacing the coating precursor.

It is to be understood that the foregoing description is merely illustrative of the technical spirit of the present disclosure and is not intended to limit the scope thereof. Various modifications and changes may be made by those of ordinary skill in the art without departing from the essential characteristics of the present disclosure.

Accordingly, the embodiments disclosed herein are not intended to limit the scope of the present disclosure but are provided for illustrative purposes only. The scope of protection of the present disclosure shall be defined by the appended claims, and all technical ideas falling within the equivalent scope thereof shall be interpreted as being included within the scope of the present disclosure.

1. A negative electrode active material for a secondary battery, comprising:
silicon forming a concentration gradient that increases from a surface region toward a core region of the active material; and
carbon forming a concentration gradient that decreases from the surface region toward the core region of the active material.

2. The negative electrode active material of claim 1,
wherein a silicon content in a core region of a particle of the active material is in a range of 95% to 100%, and
wherein a carbon content in a surface region of the particle is in a range of 95% to 100%.

3. The negative electrode active material of claim 1,
wherein a concentration gradient of the silicon has a slope in a range of −3 to 0.

4. A method for manufacturing a negative electrode active material for a secondary battery, comprising:
mixing a coating precursor material with a carrier solvent to prevent a coating precursor solution;
introducing silicon into a furnace and heating an interior of the furnace; and
introducing the coating precursor solution into the heated interior of the furnace.

5. The method for manufacturing a negative electrode active material for a secondary battery of claim 4,
wherein the coating precursor material comprises one or more substances selected from a group consisting of tetramethylsilane, tris(dimethylamino)silane, trimethyl(phenyl)silane, trimethyl(propargyl)silane, trimethyl(trifluoromethyl)silane, tert-butyldimethyl(2-propynyloxy)silane, trimethyl(methylthio)silane, trimethyl(phenylthio)silane, vinyltrimethylsilane, ethynyltrimethylsilane, triethyl(trifluoromethyl)silane, trimethylsilane, hexamethyldisilane, bromotrimethylsilane, 1-phenyl-2-trimethylsilylacetylene, and phenylsilane.

6. The method for manufacturing a negative electrode active material for a secondary battery of claim 5,
wherein a temperature for the heating is in a range of 300° C. to 1000° C.

7. The method for manufacturing a negative electrode active material for a secondary battery of claim 5,
wherein the coating precursor solution is introduced into the furnace at a flow rate in a range of 50 to 300 mL/min.

8. The method for manufacturing a negative electrode active material for a secondary battery of claim 5,
wherein a time during which the coating precursor solution is introduced into the heated furnace is in a range of 5 to 120 minutes.

9. The method for manufacturing a negative electrode active material for a secondary battery of claim 5,
wherein, as the coating precursor solution is introduced into the heated furnace, the coating precursor material is thermally decomposed and continuously deposited on a surface of the silicon.

10. The method for manufacturing a negative electrode active material for a secondary battery of claim 5,
wherein the coating precursor material is mixed with the carrier solvent in an amount of 50 to 500 parts by weight based on 100 parts by weight of the silicon.

11. A negative electrode for a secondary battery, comprising a negative electrode active material manufactured by the method according to claim 5.

1. A negative electrode active material for a secondary battery, comprising:
silicon forming a concentration gradient that increases from a surface region toward a core region of the active material; and
carbon forming a concentration gradient that decreases from the surface region toward the core region of the active material.

2. The negative electrode active material of claim 1,
wherein a silicon content in a core region of a particle of the active material is in a range of 95% to 100%, and
wherein a carbon content in a surface region of the particle is in a range of 95% to 100%.

3. The negative electrode active material of claim 1,
wherein a concentration gradient of the silicon has a slope in a range of −3 to 0.

4. A method for manufacturing a negative electrode active material for a secondary battery, comprising:
mixing a coating precursor material with a carrier solvent to prevent a coating precursor solution;
introducing silicon into a furnace and heating an interior of the furnace; and
introducing the coating precursor solution into the heated interior of the furnace.

5. The method for manufacturing a negative electrode active material for a secondary battery of claim 4,
wherein the coating precursor material comprises one or more substances selected from a group consisting of tetramethylsilane, tris(dimethylamino)silane, trimethyl(phenyl)silane, trimethyl(propargyl)silane, trimethyl(trifluoromethyl)silane, tert-butyldimethyl(2-propynyloxy)silane, trimethyl(methylthio)silane, trimethyl(phenylthio)silane, vinyltrimethylsilane, ethynyltrimethylsilane, triethyl(trifluoromethyl)silane, trimethylsilane, hexamethyldisilane, bromotrimethylsilane, 1-phenyl-2-trimethylsilylacetylene, and phenylsilane.

6. The method for manufacturing a negative electrode active material for a secondary battery of claim 5,
wherein a temperature for the heating is in a range of 300° C. to 1000° C.

7. The method for manufacturing a negative electrode active material for a secondary battery of claim 5,
wherein the coating precursor solution is introduced into the furnace at a flow rate in a range of 50 to 300 mL/min.

8. The method for manufacturing a negative electrode active material for a secondary battery of claim 5,
wherein a time during which the coating precursor solution is introduced into the heated furnace is in a range of 5 to 120 minutes.

9. The method for manufacturing a negative electrode active material for a secondary battery of claim 5,
wherein, as the coating precursor solution is introduced into the heated furnace, the coating precursor material is thermally decomposed and continuously deposited on a surface of the silicon.

10. The method for manufacturing a negative electrode active material for a secondary battery of claim 5,
wherein the coating precursor material is mixed with the carrier solvent in an amount of 50 to 500 parts by weight based on 100 parts by weight of the silicon.

11. A negative electrode for a secondary battery, comprising a negative electrode active material manufactured by the method according to claim 5.
